(19) United States
(12) Patent Application Publication
(10) Pub. No.: US 2008/0294576 A1
(43) Pub. Date: Nov. 27, 2008

(54) Direct response media distribution method

(76) Inventor: Johann B. Verheem, Carlsbad, CA (US)

Correspondence Address: CROCKETT & CROCKETT, P.C., 26020 ACERO, SUITE 200, MISSION VIEJO, CA, 92691, US

(21) Appl. No.: 12/077,743

(22) Filed: Mar. 19, 2008

Related U.S. Application Data
(60) Provisional application No. 60/919,028, filed on Mar. 19, 2007.

(51) Int. Cl. G06Q 90/00

(52) U.S. Cl. 705/500

(57) ABSTRACT

In direct response media distribution any suitable cause or NPO purchases one or more blocks of direct response time from a media outlet to present a message. The NPO coordinates with one or more advertisers to purchase (sublet) time within the direct response media time and the purchased time offsets the cost of the direct response media time and possibly some of the production cost for the message. NPOs and advertisers may select partners consistent with their positions or goals.

### RELATED APPLICATIONS

This application claims priority to copending U.S. Provisional patent application 60/919,028 filed Mar. 19, 2007.

### FIELD OF THE INVENTIONS

The inventions described below relate to the field of direct response media, specifically techniques for including short-form advertising in direct response media time to offset the cost of the direct response media time.

### BACKGROUND OF THE INVENTIONS

The landscape of commercial media changed in the U.S. in 1985 with the changes to the permissible length of commercial advertising. Media outlets no longer abandon the airwaves during hours when it was formerly uneconomical to air programming. We have entered the info-mercial heyday.

Infomercials, referred to as direct response media, are generally 28½ minute blocks of time purchased by a company to sell their products directly to consumers. The infomercial time slots are discounted by media outlets since this is time that is more cost effective for them to sell as a block, rather than running programming at an expense. In contrast, traditional short-form-advertising (30, 60, 90 and 120 second commercials) is geared to raise awareness of a brand, product or company and induce consumers to purchase the products from a commercial outlet. When an advertiser purchases direct response media time, the advertiser controls the full 28½ minutes and conventional short-form advertisers are excluded from the scene. They could never place it in the middle of a traditional advertisement because that will be competitive or destructive to both messages and infomercial companies would not do this.

### SUMMARY

There are many people concerned about global causes such as global warming, AIDS, political campaigns, or not-for-profit organizations (NPO) that could greatly benefit from the infomercial, direct response media, half hour format. If a 28½ minute show is made discussing global warming and several short-form advertising spots are sold to traditional advertisers in the 28½ minute infomercial, the media time becomes free to the organization purchasing the infomercial. The cost of the underlying 28½ minutes of media is passed through to the traditional advertisers that have embedded ads in the infomercial. Therefore, global warming or other causes du jour will have hours of time to broadcast their message, the traditional advertisers will have the opportunity to be seen as pro-earth and have access to advertising time not otherwise available. A media agent buying the media will have a new client, while the stations get paid their normal direct response advertising rates.

The direct response media distribution method enables short-form advertisers access to direct response time blocks and allows community, state, national and global cause proponents to present their messages to the public.

In direct response media distribution any suitable cause or NPO purchases one or more blocks of direct response time from a media outlet to present a message. The NPO coordinates with one or more advertisers to purchase (sublet) time within the direct response media time and the purchased time offsets the cost of the direct response media time and possibly some of the production cost for the message. NPOs and advertisers may select partners consistent with their positions or goals.

Some direct response advertising may be short in time, similar to short-form advertising. In this application, short-form will be used to refer to regular advertising that does not solicit a direct consumer response.

### BRIEF DESCRIPTION OF THE DRAWINGS

FIG. 1 is a block diagram of conventional media outlet programming.

FIG. 2 is a block diagram of direct response media distribution programming.

### DETAILED DESCRIPTION OF THE INVENTIONS

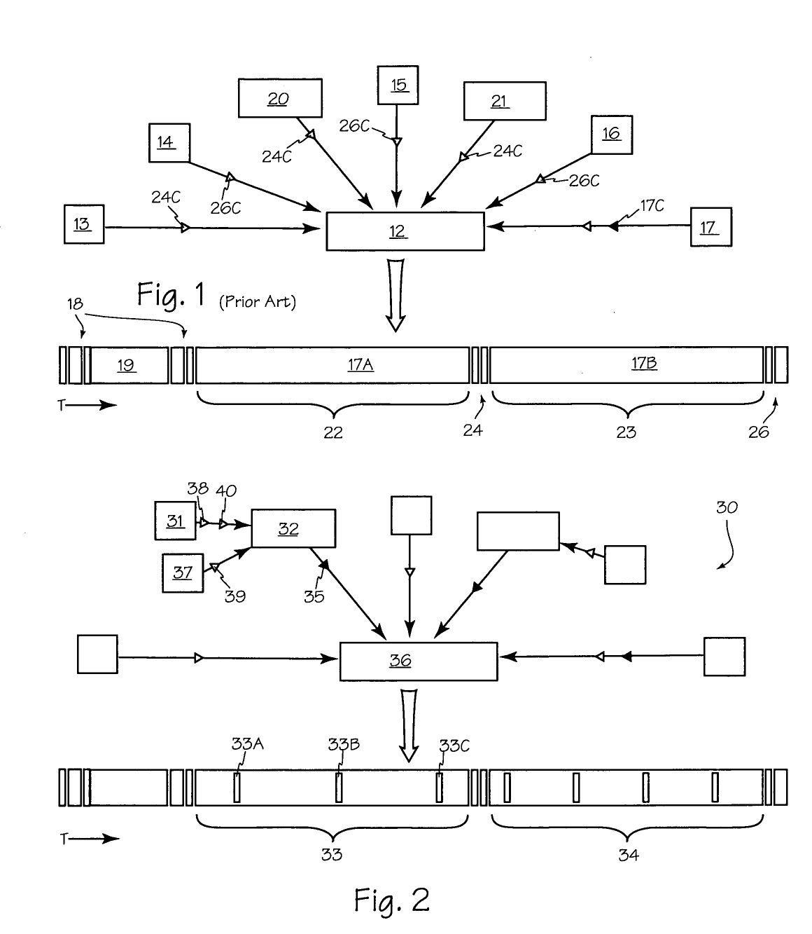

In a conventional media outlet illustrated as outlet 12 of FIG. 1 one or more advertisers such as advertisers 13 through 16 purchase time in one or more short-form advertising time slots such as slots 18 within programming 19 that media outlet 12 purchased from one or more programming producers such as producers 20 and 21. When the income from advertising time is insufficient to offset the cost of programming, media outlets sell 28½ minute blocks of time such as slots 22 and 23 to an advertiser such as advertiser 17. Advertiser 17 may present one or more infomercials such as infomercials 17A and 17B for a cost 17C. Conventional advertisers such as advertisers 13 through 16 then only have access to widely separated short-form advertising slots such as slots 24 and 26 with respective costs 24C and 26C.

In direct response media distribution system 30 of FIG. 2 any suitable organization such as NPO 32 may purchase one or more direct response media slots such as slots 33 and or 34 from a media outlet such as outlet 36 for a cost 35. NPO 32 may then negotiate with one or more advertisers such as advertiser 31 and or 37 to purchase one or more advertising time slots such as time slots 33A, 33B and 33C which are imbedded within direct response media time slot 33 for respective costs 38, 39 and 40. NPO 32 may set the price for slots 33A, 33B and 33C at a level that meets or exceeds the cost of direct response media time slot 33. Advertiser 37 may be selected as presenting a message consonant with the message of NPO 32. Thus advertisers are able to regularly present themselves to the public and associate with organizations and causes that support or improve the image of the advertiser. Organizations and causes gain access to media that may otherwise be unaffordable.

Once a cause or organization has purchased one or more direct response time slots such as slot 33 and they have contracted with one or more advertisers to present the advertisers message in one or more short form advertisements such as slots 33A, 33B and or 33C within slot 33. The cause or organization must present the content of the direct response time slot along with the one or more short form advertisements to realize the income from costs 38, 39 and or 40 as contracted with the advertisers.

While the preferred embodiments of the devices and methods have been described in reference to the environment in which they were developed, they are merely illustrative of the principles of the inventions. Other embodiments and configurations may be devised without departing from the spirit of the inventions and the scope of the appended claims.

I claim:

1. A business method comprising the steps:
purchasing one or more blocks of direct response media time at a first cost; and
selling one or more short form advertising slots to advertisers to generate revenue exceeding the first cost.

2. The business method of claim 1 further comprising the step:
presenting the one or more blocks of direct response media time with the one or more short form advertising slots to realize the generated revenue.

3. A method for a non-profit organization to present a message to the public comprising the steps:
purchasing a block of direct response media time from a media outlet at a first cost to present a message to the public; and
contracting with one or more advertisers to pay for short form advertising slots within the block of direct response media time, the payment from the one or more advertisers exceeding the first cost.
